(19) United States
(12) Patent Application Publication
(10) Pub. No.: US 2017/0149848 A1
(43) Pub. Date: May 25, 2017

(54) METHOD FOR MANAGING A CONFERENCE INVOLVING A PLURALITY OF DATA PROCESSING DEVICES

(71) Applicant: Orange, Paris (FR)

(72) Inventors: Yann Gestraud, Rennes (FR); Fabien Binard, Rennes (FR)

(21) Appl. No.: 15/127,345

(22) PCT Filed: Mar. 20, 2015
(86) PCT No.: PCT/FR2015/050709

§ 371 Date: Sep. 19, 2016

(30) Foreign Application Priority Data
Mar. 24, 2014 (FR) 1452451
Mar. 20, 2015 (FR) PCT/FR2015/050709

(51) Int. Cl. H04L 29/06; H04L 29/12; H04L 12/18

(52) U.S. Cl. CPC H04L 65/1083; H04L 65/1069; H04L 12/1818; H04L 65/4038; H04L 65/1006; H04L 61/3085

(57) ABSTRACT

The invention relates to a method for managing a conference involving a plurality of data processing devices (D1, D12, D22) communicating with one another via a communication network (RES). The devices are capable of requesting creation of a conference with a conference management module. Said module memorizes the information related to a conference created during a given duration. A created conference can be suspended and restarted after suspension if the restart request is received during the given duration from a device participating in the conference. Said method is characterized in that it includes a step for providing information related to the duration of a conference created on the devices participating in the conference. Said duration information is taken into account by the participating device when a message related to the conference is sent to the management module.

### TECHNICAL FIELD

The invention relates to a method for managing a conference; the conference involving multiple data processing devices connected via a communication network.

The devices referred to above are provided with communication means for communicating with a communication network. These devices are provided with respective client modules so as to exchange messages during a conference. A device is, for example, a PC type personal computer, a tablet, a telephone, etc.

### PRIOR ART

It is recalled that a conference is a place for exchanges where each message sent from one device is broadcast to a set of devices connected to the conference. The conference is composed of “participants”, i.e. the end users who exchange messages with one another within the framework of the conference.

Messaging tools, via the communication software tools SIMPLE IM (English acronym for “Session Initiation Protocol for Instant Messaging and Presence Leveraging Extensions” and “Instant Messaging”) and CPM (English abbreviation for “Converged IP Messaging”), as defined by the standardization organization OMA (English acronym for “Open Mobile Alliance”), enable conferences to be held between multiple client modules present on the devices. The implementation of conferences using such software tools relies on a central node in the network of a telecommunications operator, i.e. a conference management module (most often designated by the English expression “Controlling Function” by the person skilled in the art).

To create a conference, a conference management module creates a conference instance by connecting client modules. The various participants may then exchange messages.

The operating principle is as follows:
A client module transmits a request for creating a conference to its operator's conference management module; the request includes a list of invited client modules (identified by an identifier shared by all the participants);
The conference management module then creates a conference instance and transmits an invitation to each of the invited client modules; a conference identifier is created.
The invited client modules that accept the invitation are then connected to the conference instance and become participants in the conference.
Finally, each participant wishing to communicate sends his/her message to the conference instance managed by the management module originating the invitations, which transmits it to all the other participants.

When the conference identifier is created, it may be retained by the client module and/or by the conference system together with other context information such as the list of participants and the reachability addresses, for future use.

The participants may leave the conference at any time.

The life cycle rules of the conference may vary according to the service. For example, to save on network resources, the operator hosting the conference may decide, following a certain period of inactivity, e.g. due to an absence of exchange of messages, for a certain time defined by the operator, to suspend the conference, or even discontinue it beyond a certain duration.

On the resumption of activity, i.e. when a user wishes to send a message, the participant may transmit a message to another participant connected to the conference instance. However, in the case where the operator has discontinued the conference instance, the client module originating the restart request receives an error message in return.

The invention will improve the situation.

### The Invention

For this purpose, according to a functional aspect, the subject matter of the invention is a method for managing a conference involving multiple data processing devices communicating with one another via a communication network, the devices being capable of requesting the creation of a conference from a conference management module, said management module storing for a given duration the information relating to a created conference, a created conference that is able to be suspended and restarted after suspension if the restart request is received from a device participating in the conference for the given duration, characterized in that in the management module it includes a step of providing a piece of information relating to the duration of a created conference to the devices participating in the conference.

The users participating in the conference are aware, thanks to the invention, of the duration of a conference or more precisely of the duration of retention in memory of the context information relating to a conference instance which is necessary for restarting a conference when it has been suspended. This avoids unnecessarily transmitting a message in connection with the conference to the management module when the context information relating to this conference is no longer accessible. The invention thus avoids some chaotic situations and accordingly simplifies network operation, anomaly detection actions, and after-sales service.

The management module is capable of transmitting respective invitations to participate in the conference. According to a particular implementation of the invention, the information relating to the duration is transmitted in a message of invitation to participate in the conference.

The management module is capable of transmitting notifications following the sending of invitations to participate in the conference. According to another particular implementation of the invention, the information relating to the duration is transmitted in a notification relating to a change in the status of the conference.

These two implementations are advantageous in the sense that the duration is conveyed by means of existing messages notably the first message inviting participation in a conference or a message notifying a change relating to the conference.

According to a particular implementation of the invention, a message from a device participating in the conference beyond the duration is transformed into a request for creating a new conference. Thanks to this feature, the module having sent a message when the conference has been discontinued restarts a new conference in a transparent way. This reduces the number of operations associated with a recreation of a conference in particular when the duration has expired. Indeed, this avoids both the reception of an error message indicating that the conference no longer exists and a request for creating a new conference. Thanks to this feature, an optional creation of a new conference is transparent for a participant originating the message.

According to another functional aspect, the invention relates to a method for managing a participation in a conference in a client module, the conference involving multiple data processing devices communicating with one another via a communication network, the devices being capable of requesting the creation of a conference from a conference management module, said management module storing the information relating to a created conference for a given duration, a created conference that is able to be suspended and restarted after suspension if the restart request is received from a device participating in the conference for the given duration, characterized in that it includes a step of receiving a piece of information relating to the duration of a created conference and in that this duration is taken into account by the device before sending a message relating to the conference to the management module.

According to a material aspect, the invention also concerns a conference management module capable of managing a conference between multiple devices communicating with one another via a communication network, said management module including a memory for storing for a given duration information relating to a created conference, a created conference that is able to be suspended and restarted after suspension if the restart request is received from a device participating in the conference for the given duration, characterized in that it includes a module for providing a piece of information relating to a duration of the conference.

According to another material aspect, the invention also concerns a client module capable of participating in a conference, a conference that is able to be suspended and restarted after suspension if the restart request is received from a device participating in the conference for the given duration, characterized in that it includes
a. A receiving module capable of receiving a piece of information relating to the duration of the conference
b. A processing module capable of taking into account this duration before sending a message relating to the conference.

According to another material aspect, the invention also concerns a computer system including devices connected via a communication network, with a conference management module, characterized in that the management module and the client module are those defined above.

According to another material aspect, the invention also concerns a computer program including code instructions which, when the program is executed by a processor, performs the steps of the management method defined above. Such a program may use any programming language. It may be downloaded from a communication network and/or recorded on a computer readable medium.

The invention will be better understood on reading the description that follows, given by way of example and referring to the attached drawings, in which:

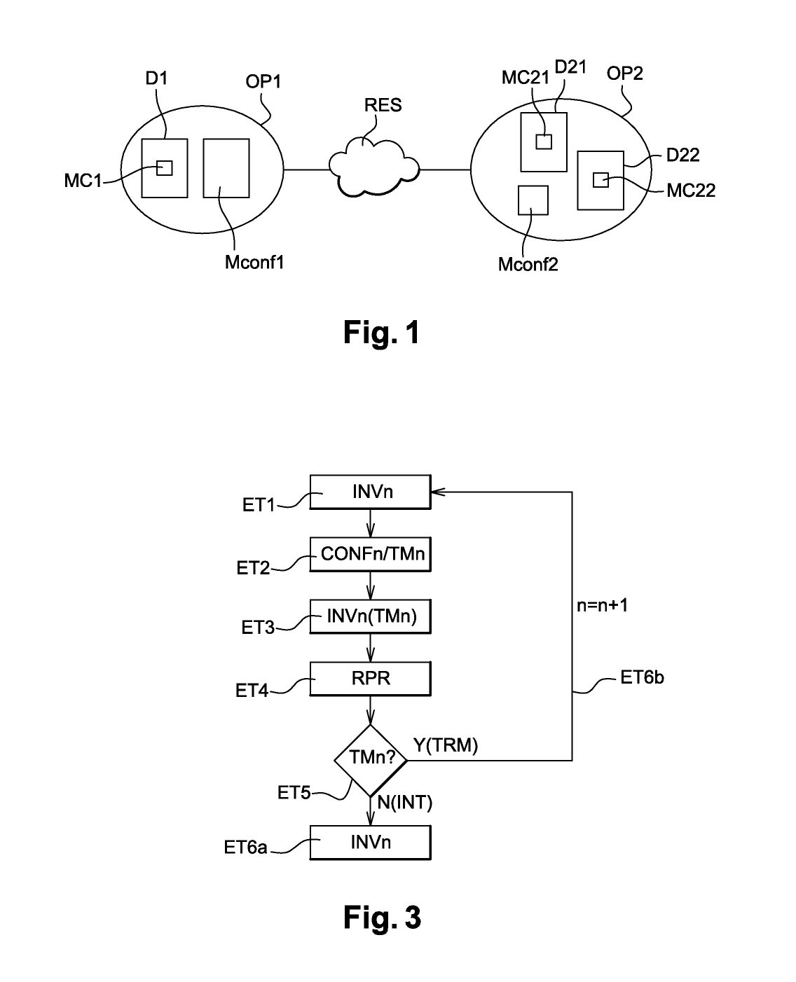

FIG. 1 represents a computer system in which the invention may be implemented according to one embodiment.

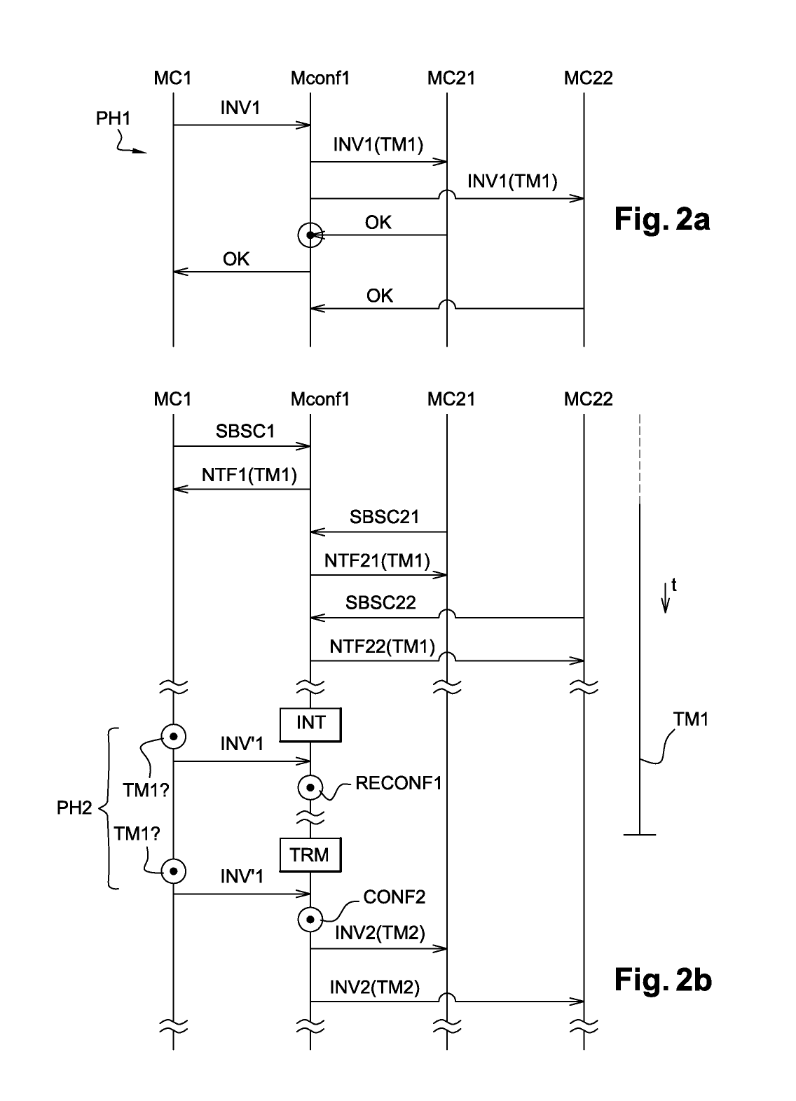

FIGS. 2a and 2b are respective schematic views of exchanges of messages according to the embodiment described with reference to FIG. 1. More precisely, FIG. 2a relates to a creation of a conference; FIG. 2b relates to managing the life cycle of the created conference.

FIG. 3 is an algorithm giving the general principle of managing the conference according to the duration of the conference.

### DETAILED DESCRIPTION OF AN EMBODIMENT ILLUSTRATING THE INVENTION

FIG. 1 represents a management system SYS including, in our example, three data processing devices (D1, D21, D23). These three devices are provided with respective processors and respective memories for data processing. The devices are also provided with physical and software resources for communicating with one another via at least one communication network RES. In our example, the communication network is the Internet network.

In our example, of the three devices, one device is managed by a first telecommunications operator OP1, and the other two by a second operator OP2.

The devices are provided with client modules MC1, MC21, MC22 respectively capable of requesting the creation of a conference and managing the exchange of messages between the client modules.

The system includes at least one conference management module. In our example, each operator OP1 and OP2 has its own conference management module MConf1 and MConf2, respectively.

In this configuration, the first client module MC1 calls upon the first conference management module MConf1, and the client modules MC21 and MC22 call upon the second conference management module MConf2.

The assumption is made here that the first client module MC1 requests the creation of a conference whereof the participants are the three devices, meaning the three client modules.

A request for creating a conference according to one embodiment of the method of the invention is performed in the following way. This embodiment is described with reference to FIGS. 2a and 2b.

FIG. 2a concerns an initial first phase PH1 related to creating a conference.

In a first step INV1 of this first phase PH1, the first client module MC1 calls for INV1 a request for creating a conference from the first conference management module MConf1 of its operator.

The request referred to above includes, inter alia, at least a list of devices invited to participate in the conference. A list includes, for example, URI (English acronym for Uniform Resource Identifier) identifiers of the type sip:b@mno_B.com and sip:c@mno_C.com 1.

Then, the first management module MConf1 receives the creation request and manages the creation of the conference in a second step CONF1. For this, the first module will create a conference instance.

Following the instance creation request, in a third step INV1 (TM1), the first module MConf1 transmits an invitation to each device identified in the creation request from the first device.

In our example, this initial invitation includes a piece of information relating to the duration TM1 of the conference CONF1 which will be created.

Then, the client modules MC21 and MC22 receive these invitations, respectively.

In our example, the first management module also transmits the duration TM1 to the first client module MC1 originating the creation request.

It should be noted that, in our example, the modules only receive a single invitation in this first phase PH1.

In a fourth step OK, the client modules acknowledge the invitations received. In our example, the management module MConf1 creates a conference on receiving at least one acceptance OK. It is assumed here that the two client modules MC21 and MC22 have sent messages of acknowledgment and that these messages are received by the conference management module MConf1.

At this stage, the conference CONF1 is created and the duration TM1 of conference CONF1 is known to the participants.

Then, with reference to FIG. 2b relating to the management of the life cycle of the conference, the first module MC1 transmits to the conference management module MConf1 a request for subscription SBSC1 to the conference CONF1 that has just been created.

In return, the first client module MC1 receives a message NTF1(TM1) notifying at least the duration TM1 of the conference.

In our embodiment, the client modules MC21 and MC22 also send to the first management module MConf1 subscription requests SBSC12 and SBSC22, respectively. The management module receives these requests and transmits notifications NTF12(TM1) and NTF22(TM1) to the client modules MC12 and MC22, respectively. These notifications NTF12 and NTF22 include in our example the duration TM1, but this is not necessary if the modules are already aware of the duration.

It is assumed here that, later, the conference has become inactive or placed on standby following a period of inactivity/non-use of the conference. This results in a suspension (or interruption) of the conference. This new status is referenced by INT in the figures. Its use then requires a restart of the conference CONF1 with the context information associated with this conference that has been stored in memory.

Following this period of non-use of the conference CONF1, a user will transmit a message in connection with the conference CONF1. Let us suppose that this user is the user of the first device.

In FIG. 2b, a restart of the conference takes place in a second phase PH2. The method for restarting the conference is as follows:

In a first step (TM1?) relating to the second phase PH2, the first client module MC1 checks whether or not the duration TM1 has expired.

If the duration TM1 has not expired, in our example, the conference instance is restarted in the following way:

In a second step INV1′ relating to the second phase PH2, the first client module MC1 transmits a command INV1′ to the first conference management module MConf1. This command INV1′, unlike the initial command INV1 relating to the first phase PH1, includes the identifier of the conference CONF1.

Since the duration TM1 has not expired, the conference management module restarts RECONF1 the conference CONF1. At this stage, the conference instance associated with the conference CONF1 is active again; the conference CONF1 is therefore re-created.

Let us suppose that, later, the conference is discontinued, the duration TM1 having expired. In this configuration, in our example, an invite command INV1′, identical to that described above, received by the management module MConf1 is, in our example, interpreted as a request for creating a new conference CONF2. A creation of a new conference CONF2 is performed according to the same steps described with reference to FIG. 2a. This will result in a new conference CONF2, and a new duration TM2, new invitations INV2(TM2), and so on.

It should be noted that the command INV1′ sent when the period has expired may result in the sending of an error message to the client module originating the message. However, advantageously the message is automatically transformed into a request for creating a new conference. Since the transformation is automatic, this will ensure a gain in time for the user wishing to recreate the conference. For this, the INV1′ command includes the information necessary for restarting a conference.

According to another variant, the duration TM1 may be modified. The resulting modification is transmitted in particular to the participants during the conference.

FIG. 3 is an algorithm relating to the principle of the invention. This algorithm clearly shows the possibility of restarting a conference CONFn discontinued for the entire duration TMn associated with the conference.

In a first step ET1, a creation request INVN is sent from the management module MConf1.

In a second step ET2, a conference MCONFn is created with an associated duration TMn.

Invitations INVn(TMn) are sent to participants, in a third step ET3.

In a fourth ET4, it is assumed that following a period of inactivity, the user of the first device requests a resumption RPR of the conference CONFn.

In a fifth step ET5, a check is made.

If the duration TMn has expired, and that therefore the conference has been discontinued, in a sixth step ET6b a new conference CONF (n+1) is created.

If the duration TMn has not expired, and that therefore the conference is suspended, in a sixth step ET6a the conference CONFn is restarted.

As mentioned above the invention may be implemented under the standard GSMA RCS 5.1 incorporated by reference. This standard defines multiple commands such as the command SIP-INVITE. This command is representative of a request for creating a conference (see step INV1 above); it is transmitted to the conference management module. According to a first variant, the management module inserts the information relating to the duration into the SIP INVITE commands transmitted to the participants. This duration is conveyed, for example, in a new attribute of the SIP header Contribution-Id for Simple IM, or Conversation-Id for CPM.

Other commands are defined, notably the command SIP-SUBSCRIBE, SIP NOTIFY FULL, SIP NOTIFY PARTIAL.

The command SIP SUBSCRIBE is transmitted by the client modules wishing to participate in the conference.

After receiving SIP SUBSCRIBE commands, the participants concerned receive SIP NOTIFY notifications from the conference management module MConf1; a first SIP NOTIFY FULL notification and next SIP NOTIFY PARTIAL notifications which follow on from events related to the conference e.g. the arrival of a new participant. The SIP NOTIFY FULL notification gives information on the current status of the conference (number of users, status of each participating user, etc.). The SIP NOTIFY PARTIAL notification gives information on changes in the status of the conference.

The events referred to above are, for example:
Connection of a new participant to the conference
Voluntary departure of a participant
Involuntary departure of a participant
Addition of a new participant

According to a second variant, in our example, the duration is conveyed through a SIP NOTIFY FULL and/or SIP NOTIFY PARTIAL notification.

In our example this notification is in XML format. The information relating to the duration of the conference (conference-lifetime) is added by the conference management module in an XML tag. It may be written as follows:

<conference-description>

...
<conference-lifetime>[conf-lifetime]</conference-lifetime>

...

</conference-description>

In our example, “conference-lifetime” is an attribute that corresponds to the end date of the conference in UTC format (English abbreviation for “Coordinated Universal Time”). Any method is used for calculating the value of this attribute. The value may be obtained by adding the conference creation date and a maximum conference duration. The maximum duration is, for example, provided by the creator of the conference e.g. the first management module with reference to the example described above.

According to one variant, the information relating to the duration may also be a piece of information relating to the time remaining. For example, the client modules receive an attribute indicating X seconds before the discontinuance of the conference.

For the embodiment of the invention, a management module MConf1 has the following modules:
a module for adding, in a message intended for client modules participating in a conference, a piece of information associated with the duration relating to the conference in the invitation,
a module for transmitting the resulting message to the devices of the participants in the conference.

For the embodiment of the invention, a client module capable of participating in a conference has the following modules available to it:
a. A receiving module capable of receiving a piece of information relating to the duration of the conference
b. A processing module capable of taking into account this duration before sending a message relating to the conference.

It should be noted here that the term module used in the present application may equally correspond to a software component, a hardware component or a set of hardware and software components, a software component itself corresponding to one or more computer programs or sub-programs or more generally to any element of a program capable of implementing a function or a set of functions such as those described for the modules concerned. In the same way, a hardware component corresponds to any element of a set of hardware capable of implementing a function or a set of functions for the module concerned (integrated circuit, smart card, memory card, etc.).

1. A method for managing a conference involving multiple data processing devices (D1, D12, D22) communicating with one another via a communication network (RES), the devices being capable of requesting the creation of a conference from a conference management module (MConf1), said management module storing for a given duration the information relating to a created conference, a created conference that is able to be suspended and restarted after suspension if the restart request is received from a device participating in the conference for the given duration, characterized in that in the management module it includes a step of providing a piece of information relating to the duration (TM) of a created conference to the devices participating in the conference.

2. The management method as claimed in claim 1, characterized in that the management module is capable of transmitting respective invitations (INV) to participate in the conference, and in that the information relating to the duration is transmitted in a message of invitation to participate in the conference.

3. The management method as claimed in claim 1, characterized in that the management module is capable of transmitting notifications (NOTIFY) following the sending of invitations to participate in the conference, and in that the information relating to the duration is transmitted in a notification relating to a change in the status of the conference.

4. The method as claimed in claim 1, characterized in that a message from a device participating in the conference beyond the duration is transformed into a request for creating a new conference.

5. A method for managing a participation in a conference in a client module, the conference involving multiple data processing devices (D1, D12, D22) communicating with one another via a communication network (RES), the devices being capable of requesting the creation of a conference from a conference management module (MConf1), said management module storing the information relating to a created conference for a given duration, a created conference that is able to be suspended and restarted after suspension if the restart request is received from a device participating in the conference for the given duration, characterized in that it includes a step of receiving a piece of information relating to the duration (TM) of a created conference and in that this duration is taken into account by the device before sending a message relating to the conference to the management module.

6. A conference management module (NConf1) capable of managing a conference (CONF1) between multiple devices (D1, D12, D22) communicating with one another via a communication network (RES), said management module including a memory for storing for a given duration information relating to a created conference, a created conference that is able to be suspended and restarted after suspension if the restart request is received from a device participating in the conference for the given duration, characterized in that it includes a module for providing a piece of information relating to a duration of the conference.

7. A client module (MC1, MC21, MC22) capable of participating in a conference, a conference that is able to be suspended and restarted after suspension if the restart request is received from a device participating in the conference for the given duration, characterized in that it includes
a. A receiving module capable of receiving a piece of information relating to the duration of the conference
b. A processing module capable of taking into account this duration before sending a message relating to the conference.

8. A computer system including devices connected via a communication network, the devices including client modules, the system further including a conference management module, characterized in that the management module comprises a conference management module (NConf1) capable of managing a conference (CONF1) between multiple devices (D1, D12, D22) communicating with one another via a communication network (RES), said management module including a memory for storing for a given duration information relating to a created conference, a created conference that is able to be suspended and restarted after suspension if the restart request is received from a device participating in the conference for the given duration, characterized in that it includes a module for providing a piece of information relating to a duration of the conference; and the client module comprises a client module (MC1, MC21, MC22) capable of participating in a conference, a conference that is able to be suspended and restarted after suspension if the restart request is received from a device participating in the conference for the given duration, characterized in that it includes
a. a receiving module capable of receiving a piece of information relating to the duration of the conference
b. a processing module capable of taking into account this duration before sending a message relating to the conference.
